(19) United States
(12) Patent Application Publication
(10) Pub. No.: US 2008/0140502 A1
(43) Pub. Date: Jun. 12, 2008

(54) METHOD AND SYSTEM FOR CREATING ADVERTISEMENTS ON BEHALF OF ADVERTISERS BY CONSUMER-CREATORS

(75) Inventors: MICHAEL B. BIRNHOLZ, OAKLAND PARK, FL (US); SCOTT P. WEINER, FORT LAUDERDALE, FL (US); JEFF ROSCHMAN, FORT LAUDERDALE, FL (US)

Correspondence Address: AKERMAN SENTERFITT, P.O. BOX 3188, WEST PALM BEACH, FL, 33402-3188, US

(73) Assignee: VIEWFOUR, INC., FORT LAUDERDALE, FL (US)

(21) Appl. No.: 11/608,118

(22) Filed: Dec. 7, 2006

(51) Int. Cl. G06Q 30/00

(52) U.S. Cl. 705/10; 705/27; 705/14

(57) ABSTRACT

A method (10) and system (200) for enabling consumer-creators to create advertisements on behalf of advertisers on an electronic network includes the uploading or creating (11) of an ad on a given website by a consumer-creator and offering (12) the ad to advertisers or publishers or visitors for presentation on various medium (electronic or otherwise) where the ad can be available on the given website or linked to the given website from another website. The method can enable (14) the selection of an ad (that has been uploaded or created by the consumer-creator) by an advertiser or a publisher or visitor. The method can also broker (16) a relationship among the consumer-creator, visitor, advertiser, or publisher. The method can also track (19) usage of the ad and automatically enable (23) payment for the use of the ad based on the relationship brokered and the use tracked of the ad.

### FIELD

This invention relates generally to electronic or consumer generated advertising, and more particularly to a method and system for enabling consumer-creators to create (or upload), publish, and share revenue from advertisements or endorsements.

### BACKGROUND

Advertising and marketing has generally been within the realm of advertisers and companies and not the consumers of services or goods provided by such advertisers or companies. Although the practical mechanism that many consumers use for ultimately making a purchasing decision rests on word-of-mouth recommendations instead of relying on conventional advertising, current technology has failed to fully take advantage of this reality. With the advent of the Internet and social networking using computer networks, new opportunities to advertise incorporating the advantages and realities of “word-of-mouth” recommendations abound. Current advertising using the Internet continues to proliferate the conventional style of notion of advertising and fails to capitalize on consumer generated advertising.

Advertising on the Internet has become quite sophisticated, but also prone to practices that might tend to deceive advertisers of the true value of such advertising. Since much of the advertising and revenue based on the Internet is currently based on tracking clicks or click-throughs to websites or preferential placement on websites in the form of banners or pop-ups or preferential placement on search engine results, some unscrupulous marketing companies and advertisers try to manipulate such advertising schemes to the detriment of the consumers and some of the advertisers themselves.

Many consumers are generally savvy and will trust an endorsement from a friend or trusted individual rather than an advertisement or advantageous search result placement provided to them on the Internet. Unfortunately, no existing system enables a systematic way of recognizing such individual endorsements that would automatically benefit both the advertisers and consumers of such goods or services being endorsed. Other companies that generate revenue from online advertising have advertising agencies or the companies themselves writing the ads providing uninspiring often generic and sometimes misleading ads that are generally not trusted and often intrusive to a typical online consumer.

### SUMMARY

Embodiments in accordance with the present invention can enable individuals, coined herein as “consumer-creators” to create ads, publish or allow publication of such ads in any number of mediums and further establish a relationship with an advertiser that can share revenue resulting from such ads with the consumer-creators.

In a first embodiment of the present invention, a method of enabling consumer-creators to create advertisements on behalf of advertisers on an electronic network can including the steps of uploading or creating an ad on a given website by a consumer-creator, and offering the ad to advertisers or publishers or visitors for presentation on various electronic medium in the form selected among text, audio, video, image, flash, swift, interstitials, animated gif or any other viable media that can be viewed with commercially available electronics, where the ad is available on the given website or linked to the given website from another website. The created ad can also be made available on other media including existing traditional advertising channels as well as newer channels that can be thought of in the context herein as consumer generated advertising using podcasting or zunecasting (i.e., audio or video podcasting respectively) as examples. The method can further include the steps of selecting an ad (that has been uploaded or created by the consumer-creator) by an advertiser or a publisher or visitor, brokering a relationship among the consumer-creator, the visitor, the advertiser, or the publisher, tracking usage of the ad, and automatically enabling payment for the use of the ad based on the relationship brokered and the use tracked of the ad. The ad can be placed on a website that automatically links an ad on a third party's website that redirects a visitor to a third party's website and ultimately to an advertisers' website. The method enables visitors to view ads uploaded or created on the given website and further enables the visitors to directly click the ad and visit the advertisers website. The advertiser can be optionally charged a fee for viewing the ad at the given website (known as an impression). The method can further charge the advertiser a different fee if the visitor affirmatively opts to be linked to a website associated with the ad.

In other aspects of the first embodiment, the given website can enable a visitor or a consumer-creator to join a social network on the given website or on a third party website and to have personalized web storage space where the ad can be placed and enable the consumer-creator to share in advertising revenue based on monitored traffic resulting from the ad. The given website can automatically charge the advertiser a fee based on unique click-throughs to an advertiser website resulting from the ad generated by the consumer-creator. The advertiser can view ads created for the advertiser, approve the ads, deny the ads, and modify the ads. An email or traditional mail can be used to automatically generate and send notification to the consumer-creator if the ad was approved by the advertiser. The method can also enable the offering of a commission or a lump sum buyout by the advertiser to the consumer-creator and the advertiser can further determine rates for the commission or the lump sum based on existing statistics for the ad or other variables and the intended use by the advertiser. The method can allow an advertiser to access websites and statistics about where ads generated by the consumer-creator are being displayed or distributed and further allow the advertiser to optionally ban a website or a category of website from using their ad. Such a ban can automatically generate an email or other correspondence to the consumer-creator or publisher informing them of the ban. The method can also allow the advertiser, consumer-creator, publisher or visitor to view ranking of ads and further see statistics for the ads relating to number of ads, number of pages the ad is displayed on, number of gross clicks received from the ad, number of unique clicks received from the ad, or an estimated amount of revenue generated from click-throughs.

In yet other aspects of the embodiments of the invention, the method can further enable solicitations from the advertiser for a particular type of ad with an offer at a fixed price or a bid price and an option request for ads from a particular type of consumer-creator. The method can enable a consumer-creator to inform the given website that the consumer-creator is also a publisher, affiliate or advertiser. The consumer-creator can select an advertiser by which the consumer-creator will associate the ad where the given website automatically assigns a URL and a tracking identification ID or number for the selected advertiser to be associated with the ad. The method can be set up to only allow the advertiser to change the URL once the ad is published. The method can further enable consumer-creators to login and allow consumer-creators to see ads that they have created with associated statistics among number of sites the ad was placed on, number of clicks the ad has received, total dollars of revenue generated from the ad, gross clicks, unique clicks, geographic and other demographic data. Consumer-creators can also login and upload, create, delete or edit ads, where edits to the ad automatically disables ads at a publisher's site if the publisher or advertiser elected to have all ads approved. A subsequent approval of an edited ad will automatically generate an email or other correspondence to the consumer-creator. The publishers can use a contextually sensitive ad feed supplied by the given website that uses the content of a publisher's website to determine which ad from the given website to be placed on a publisher's website. The method also enables a publisher to retrieve HTML code generated at the given website and place the HTML code in their online publications, wherein the HTML is compatible with all publicly available web browsers including Internet Explorer, FireFox, Safari and other iterations of same.

Publishers who are not consumer-creators can receive a percentage of click-through revenue generated at their publication, where a minimum rate is established for advertisers to pay for each ad. Publishers can see ads that the publishers have selected to be displayed at their publication, along with various statistics that include among number of ads shown, pages the ad was placed on, number of clicks the ad has received, total revenue generated, gross clicks, unique clicks, and other geographic and analytical data snippets that are valuable to the publisher to determine which ads to remove or keep on the publisher's publication. A publisher can also delete ads that the publisher finds offensive or inappropriate for their site. The method can then automatically disable the ad on all of the Publishers pages and additionally inform the consumer-creator via email that a given ad was removed due to its content. A publisher can opt-in to receive an email notification if an ad is changed by the consumer-creator. A publisher can modify the ad feed that the given website suggests.

The method further enables the registration by an affiliate and further enables the affiliate to see all of the users that signed up as a result of their referral and the revenue the affiliate has generated as well as some statistical data among geographic and SIC grouped information for purposes of helping the affiliate enhance their referral activities. Affiliates are those who do not necessarily create ads, but simply refer advertisers, publishers, and creators to the given website. An affiliate can potentially benefit in the form of a ‘commission’ paid for by advertisers. The method can also track how many consumer-creators created an ad for an advertiser's website, track how many consumer-creators or visitors clicked on the ad, or track how consumer-creators or visitors viewed the ad. The method can also allow a consumer-creator to use a ‘wizard’ style interface to build an ad. The method can also enable a consumer creator to enter a keyword to search an electronic database that returns a list of SIC and or NAICS descriptions to identify a government industry specification, enable the selection of companies assigned to the government industry specification, store a company identifier and URL associated with a selected company, and pre-populate an online form to associate the ad with the information associated with the selected company. The method can further enable the selection of an ad type, display a title, content, and keyword boxes for the ad, and generate HTML code for transfer to other web pages by storing the HTML code in the consumer-creator's local memory.

In a second embodiment of the present invention, an advertising portal can include means for uploading or generating an ad to the advertising portal by a consumer-creator, means for offering the ad to advertisers, publishers, or visitors to the advertising portal, means for selecting the ad, means for brokering a relationship between a consumer-creator, the advertisers, the publishers, or the visitors, means for tracking the ad selected using link driven statistical analysis, means for automatic payment to the consumer-creator, publishers or visitors based on the relationship brokered and the statistical analysis, and means for an advertiser to request an ad to be created by a consumer-creator.

In a third embodiment of the present invention, a machine-readable storage having computer program with a plurality of code sections executable by a machine can cause the machine to perform the steps described above, namely, uploading or creating an ad on a given website by a consumer-creator, offering the ad to advertisers or publishers or visitors for presentation on various electronic medium, wherein the ad is available on the given website or linked to the given website from another website, enabling a selection of an ad by an advertiser or a publisher or visitor that has been uploaded or created, brokering a relationship among the consumer-creator, the visitor, the advertiser, or the publisher, tracking use of the ad, and automatically enabling payment for the use of the ad based on the relationship brokered and the use tracked of the ad. Among the many functions the computer program can do, the machine-readable storage can further be programmed to enable an advertiser to access websites or statistics about where their ads are being displayed or distributed and further enables the advertiser to optionally ban a website or a category of website from using their ad, wherein such a ban automatically generates an email to the consumer-creator or publisher informing them of the ban. The machine-readable storage can further be programmed to modify or translate a created or uploaded ad and any corresponding code or script into a format for use on a publisher or host website having known restrictions that may not necessarily allow an ad in a particular format.

In a fourth embodiment of the present invention, a method of ranking consumer-creator generated ads for use on a website on a computer network can include the steps of enabling the uploading or creating of an ad on a given website by a consumer-creator, placement of the ad on a third party website such that the ad enables click-throughs to an advertiser website, tracking how many consumer-creators created an ad for the advertiser website and ranking the ad based on the tracking which can include many metrics generated by the given or third party website. The method can further display the ad in an order based on the ranking. The method can track how many visitors or consumer-creators clicked on the ad or track how many consumer-creators or visitors viewed the ad or alternatively track how many unique visitors or unique consumer-creators clicked on the ad or track how many unique consumer-creators or unique visitors viewed the ad. The method can further offer the ad to advertisers or publishers or visitors for presentation on various electronic medium where the ad is available on the given website or linked to the given website from another website, enable the selection of an ad by an advertiser or a publisher or visitor that has been uploaded or created, broker a relationship among the consumer-creator, the visitor, the advertiser, or the publisher, tracking a use of the ad, and automatically enable payment for the use of the ad based on the relationship brokered and the use tracked of the ad.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a midlet, a source code, an object code, a shared library/dynamic load library and/or other sequence of instructions designed for execution on a computer system. The “processor” as described herein can be any suitable component or combination of components, including any suitable hardware or software, that are capable of executing the processes described in relation to the inventive arrangements.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a flow chart of a method of enabling consumer-creators to create advertisements on behalf of advertisers on an electronic network in accordance with an embodiment of the present invention.

FIG. 2 is a continuation of the flow chart of FIG. 1 in accordance with an embodiment of the present invention.

FIG. 3 is a screenshot of a website enabling the creation or uploading and posting of ads in accordance with an embodiment of the present invention.

FIG. 4 is a screenshot of a login screen for the website of FIG. 3 in accordance with an embodiment of the present invention.

FIG. 5 is a screenshot of a click-wrap license for the website of FIG. 3 in accordance with an embodiment of the present invention.

FIG. 6 is a screenshot of the website of FIG. 3, where the website enables the selection of a company and/or industry class in accordance with an embodiment of the present invention.

FIG. 7 is a screenshot of the website of FIG. 3, where the website enables the selection among different forms of advertising in accordance with an embodiment of the present invention.

FIG. 8 is a screenshot of the website of FIG. 3, where the website enables the input of an ad in accordance with an embodiment of the present invention.

FIG. 9 is a screenshot of the website of FIG. 3, where the website enables the preview of the uploaded or created ad and review of HTML code in accordance with an embodiment of the present invention.

FIG. 10 is a screen shot of the website of FIG. 3, where advertisers are able to approve or deny ads in accordance with an embodiment of the present invention.

FIG. 11 is a screen shot of the website of FIG. 3, where advertisers can review statistics associated with the ads made for them in accordance with an embodiment of the present invention.

FIG. 12 is a screen shot of a third party website containing multiple ads generated by the embodiments herein further indicating a trust rating in accordance with an embodiment of the present invention.

FIG. 13 is a block diagram of a system enabling consumer-creators to create advertisements on behalf of advertisers on an electronic network in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

Embodiments herein can be implemented in a wide variety of exemplary ways that can enable a user to create or upload ads to a website, and extract HTML code for use on other websites enabling others to link to the website or an advertiser's website. The embodiments can further facilitate or broker a relationship between the user (also known as a consumer-creator) and advertisers or publishers to enable the sharing of advertising revenue. Other embodiments provides for ranking of ads that is unique for the context of consumer generated advertising.

With online content rapidly expanding, marketers seeking new opportunities to push their own content online and create bonds between their brands and consumers. The quest for creating such bonds in the online world has generally failed, but the embodiments herein shifts the balance of power in the marketing world back to consumers in order to regain or create new bonds that have yet to be seen from online advertising. Online advertising will entice and enable consumers to tell a brand's story since it is the consumer and not the advertisers themselves that truly yield the most influence in purchasing decisions. The advent of social networking sites will only expand the influence of such consumer generated advertising in the near future.

Embodiments herein can bring “Consumer Generated Advertising” to a new level where a website enables consumers to create advertisements for their favorite brands. By allowing the consumer to create the ad, a new level of trust is put forward. Until now, “Word of Mouth” has been the best way to sell goods and services notwithstanding that an advertiser has virtually no control over the person or persons telling others how good a product or service might be. Advertisers relied on friends telling friends.

An embodiment of the invention can provide for a community where the consumers themselves create the ads, and yet get paid for doing so. Of course the issue of trust is ever present in “Word of Mouth” generated sales (particularly when such ads are ultimately paid for by the advertisers) and the embodiments herein also contemplate a method of gauging how trustworthy a particular consumer-creator can be. One online embodiment uses a “Trusted Consumer” method. Each ad creator can have a level of trust determined by the consumers. This level of trust can be quantified and printed next to every ad or otherwise made available as associated with a particular ad. This quantification gives the ad creator (consumer-creator) an incentive to keep their level of trust very high in order to make more money. Therefore, only the best products or services will be advertised or endorsed. In one arrangement, the consumer-creator making the trusted ad gets rewarded, the company selling the product gets rewarded, and the publisher of the ad gets rewarded.

Until now, ads have been created by companies and placed on the Internet to generate sales. All consumers realize that when seeing an ad the intent is to sell the consumer a product. This typically generates an instant sense of skepticism by the consumer because they know they are trying to be sold. By having the consumer create the ad, and the publisher putting the most trusted ads online, this skepticism can be diminished and more purchases are transacted using less of an advertising budget. Instead of one person telling another person using the conventional “word of mouth”, one person can now tell millions of people using an online method.

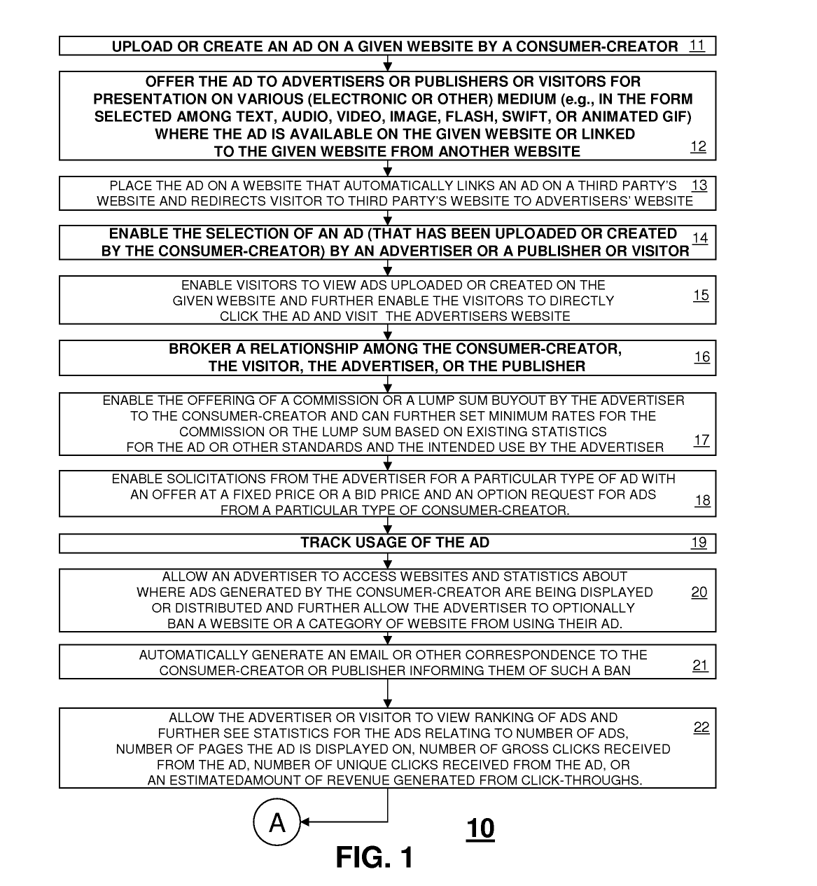

Referring to FIG. 1, a flow chart illustrating a method 10 of enabling consumer-creators to create advertisements on behalf of advertisers on an electronic network can including the step 11 of uploading or creating an ad on a given website by a consumer-creator and offering at step 12 the ad to advertisers or publishers or visitors for presentation on various electronic medium in the form selected among text, audio, video, image, flash, swift, podcasted data, zunecasted data, or animated gif where the ad is available on the given website or linked to the given website from another website. The ad can also be offered for publication or presentation on both traditional advertising media (such as TV, radio, billboards and print media) as well as any future contemplated avenues of advertising (e.g., streaming data to cellular phones or podcasting to portable devices). The ad at step 13 can be placed on a website that automatically links the ad on a third party's website that redirects a visitor (to the third party's website) to an advertisers' website. At step 14, the method can enable the selection of an ad (that has been uploaded or created by the consumer-creator) by an advertiser or a publisher or visitor. Visitors can optionally view ads uploaded or created on the given website and further directly click the ad and visit the advertiser's website at step 15. The method can also broker a relationship among the consumer-creator, the visitor, the advertiser, or the publisher at step 16. At step 17 an offer of a commission or a lump sum buyout by the advertiser to the consumer-creator can be made and the method can further set minimum rates for the commission or the lump sum based on existing statistics for the ad or other standards and the intended use by the advertiser. The method can enable solicitations from the advertiser for a particular type of ad with an offer at a fixed price or a bid price and an option request for ads from a particular type of consumer-creator at step 18.

In another aspect of the embodiments of the invention, the method can track usage of the ad at step 19 by allow an advertiser to access websites and statistics about where ads generated by the consumer-creator are being displayed or distributed and further allow the advertiser to optionally ban a website or a category of website from using their ad at step 20. The method at step 21 can automatically generate an email or other correspondence to the consumer-creator or publisher informing them of such a ban. At step 22 the method can allow the advertiser or visitor to view ranking of ads and further see statistics for the ads relating to number of ads, number of pages the ad is displayed on, number of gross clicks received from the ad, number of unique clicks received from the ad, or an estimated amount of revenue generated from click-throughs.

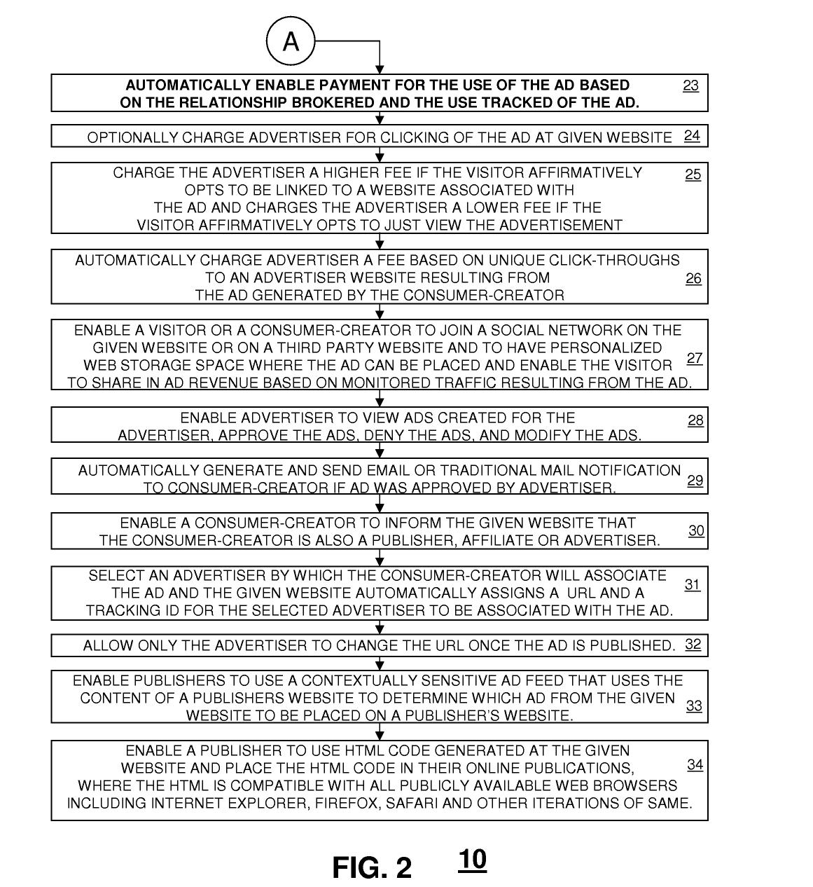

In another aspect of the embodiments and with reference to FIG. 2, the method 10 can automatically enable payment for the use of the ad based on the relationship brokered and the use tracked of the ad at step 23. At step 24, the method can optionally charge the advertiser for clicking of the ad at the given website and at step 25 the method can charge the advertiser a higher fee if the visitor affirmatively opts to be linked to a website associated with the ad and charges the advertiser a lower fee if the visitor affirmatively opts to just view the advertisement. At step 25, the advertiser can be automatically charged a fee based on unique click-throughs to an advertiser website resulting from the ad generated by the consumer-creator. At step 27, the method enables a visitor or a consumer-creator to join a social network on the given website or on a third party website and to have personalized web storage space where the ad can be placed and enabling the visitor to share in advertising revenue based on monitored traffic resulting from the ad.

At step 28, the method can enable an advertiser to view ads created for the advertiser, approve the ads, deny the ads, and modify the ads. At step 29, the method can send email or traditional mail to automatically generate and send notification to the consumer-creator if the ad was approved by the advertiser. The method can also enable a consumer-creator to inform the given website that the consumer-creator is also a publisher, affiliate or advertiser at step 30. The method can also select an advertiser by which the consumer-creator will associate the ad where the given website automatically assigns a URL and a tracking identification number for the selected advertiser to be associated with the ad at step 31. At step 32, only the advertiser will be allowed to change the URL once the ad is published. The method can enable publishers to use a contextually sensitive ad feed that uses the content of a publisher's website to determine which ad from the given website to be placed on a publisher's website at step 33. The method can also enable a publisher at step 34 to use HTML code generated at the given website and place the HTML code in their online publications, where the HTML is compatible with all publicly available web browsers including Internet Explorer, FireFox, Safari and other iterations of same.

The methods in accordance with the embodiments are certainly not limited to the steps described above or limited by the order in which they are presented or described. Other aspect of the embodiments can enable consumer-creators to login and allow consumer-creators to see ads that they have created with associated statistics among number of sites the ad was placed on, number of clicks the ad has received, total dollars of revenue generated from the ad, gross clicks, unique clicks, geographic and other demographic data. Consumer-creators can also login and upload, create, delete or edit ads, where edits to the ad automatically disables ads at a publisher's site if the publisher or advertiser elected to have all ads approved. A subsequent approval of an edited ad will automatically generate an email or other correspondence to the consumer-creator.

Publishers who are not consumer-creators can also receive a percentage of click-through revenue generated at their publication, where a minimum rate can be established for advertisers to pay for each ad. Publishers can see ads that the publishers have selected to be displayed at their publication, along with various statistics that include among number of ads shown, pages the ad was placed on, number of clicks the ad has received, total revenue generated, gross clicks, unique clicks, and other geographic and analytical data snippets that are valuable to the publisher to determine which ads to remove or keep on the publisher's publication. A publisher can also delete ads that the publisher finds offensive or inappropriate for their site. The method can then automatically disable the ad on all of the Publishers pages and additionally inform the consumer-creator via email that a given ad was removed due to its content. A publisher can opt-in to receive an email notification if an ad is changed by the consumer-creator. The method can further enable the registration by an affiliate and further enables the affiliate to see all of the users that signed up as a result of their referral and the revenue the affiliate has generated as well as some statistical data among geographic and SIC grouped information for purposes of helping the affiliate enhance their referral activities. The method can also track how many consumer-creators created an ad for an advertiser's website, track how many consumer-creators or visitors clicked on the ad, or track how consumer-creators or visitors viewed the ad. The method can also allow a consumer-creator to use a ‘wizard’ style interface to build an ad. The method can also enable a consumer creator to enter a keyword to search an electronic database that returns a list of SIC and or NAICS descriptions to identify a government industry specification, enable the selection of companies assigned to the government industry specification, store a company identifier and URL associated with a selected company, and pre-populate an online form to associate the ad with the information associated with the selected company. The method can further enable the selection of an ad type, display a title, content, and keyword boxes for the ad, and generate HTML code for transfer to other web pages by storing the HTML code in the consumer-creator's local memory.

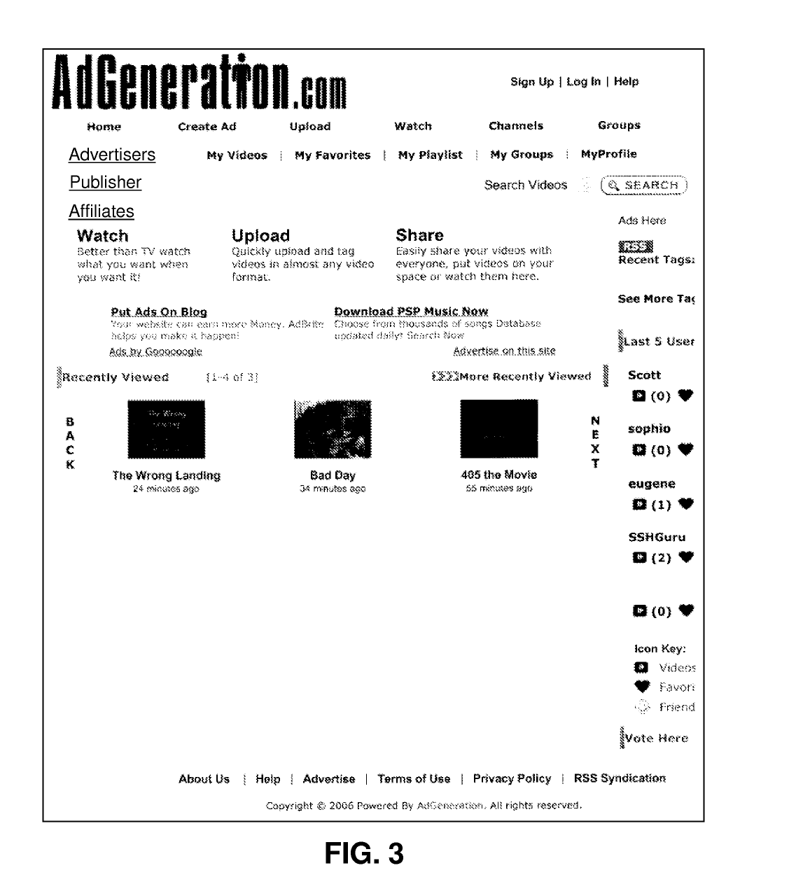

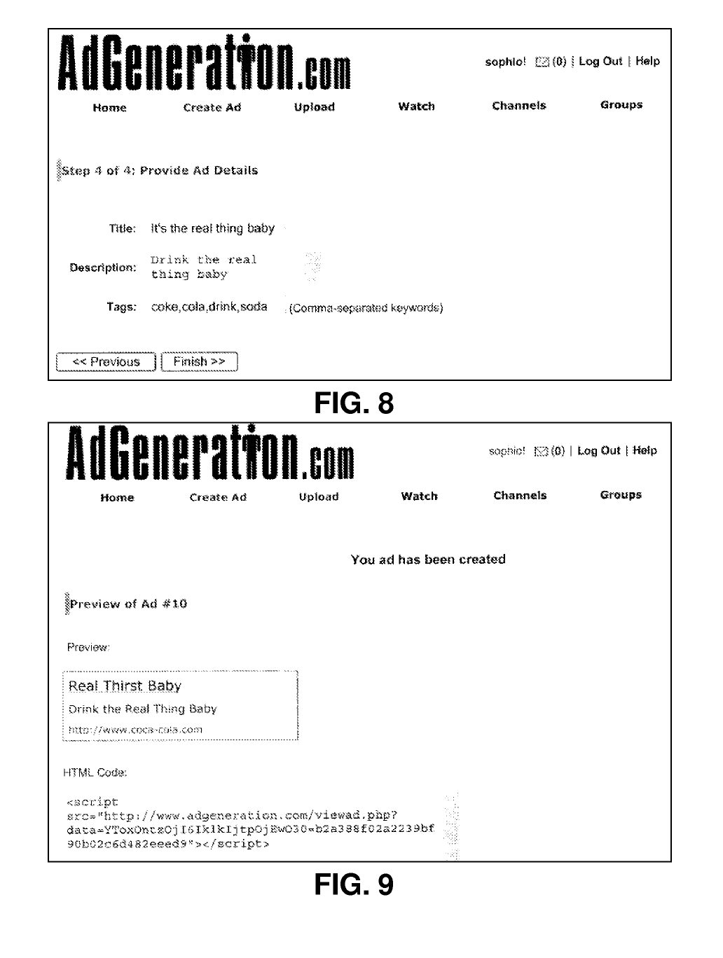

Referring to FIGS. 3-9, a website in accordance with an embodiment of the invention can specifically facilitate the posting of advertisements or endorsements that an individual or business (consumer-creators) can create on behalf of advertisers. In addition, advertisers can post or solicit for ads to be submitted by the same individuals and businesses that have already created or uploaded an advertisement and submit it for buyout or residual earnings. The advertiser's solicitation can also be directed toward a general population as well and not necessarily limited to existing consumer-creators.

As noted in FIG. 3, a user, whether a consumer creator, an advertiser, a publisher, an affiliate, or other guest or visitor to the website can log in. The website or system in general can further broker a relationship among the parties and receive a fee. The created or uploaded ads (or creatives) can be in the form of plain text, audio, video, podcasts, and other forms of multimedia that can be easily published on the Internet or other areas of distribution including, but not limited to newspapers, periodicals, billboards, radio, satellite radio, public television, cable television, satellite television, portable electronic media devices (MP3 players, audio and video ipods, cellular phones, laptop computers, etc.), or video on demand. One underlying assumption of the desire for such a system is the belief that consumers often do a better job at advertising or endorsing a product or service by ‘word of mouth’ than advertisers who spend excessive amounts of money and time in convincing a target audience or the general public that a product or service is worth purchasing. Consumers generally accept a friend's or a relative's praise about a company's product or service more readily than an advertisement by the company themselves.

For further clarification, each type of user that can use a website or system in accordance with the embodiments shall be described in further detail. The list of users can include: 1) Visitor; 2) Advertiser; 3) Creator; 4) Publisher; and 5) Affiliate.

A visitor can be an everyday web surfer who comes to a given website to see ads that have been created in the social network or elsewhere. This can be done primarily for entertainment value only. However, if a visitor clicks an advertisement with the intent of seeing the website being promoted, the advertiser can be charged. A visitor can view the advertisements without causing the advertiser to be billed if the given website asks the visitor if they really want to visit the advertiser's website. This can be done in an effort to more fairly charge the advertiser for targeted advertising. In other words, efforts can be made to avoid having the advertiser to pay or at least fully pay for clicks that they do not want or a potentially consumer really didn't intend to view. Thus, an impression charge can be charged instead that can be a fractional amount of the total click through cost.

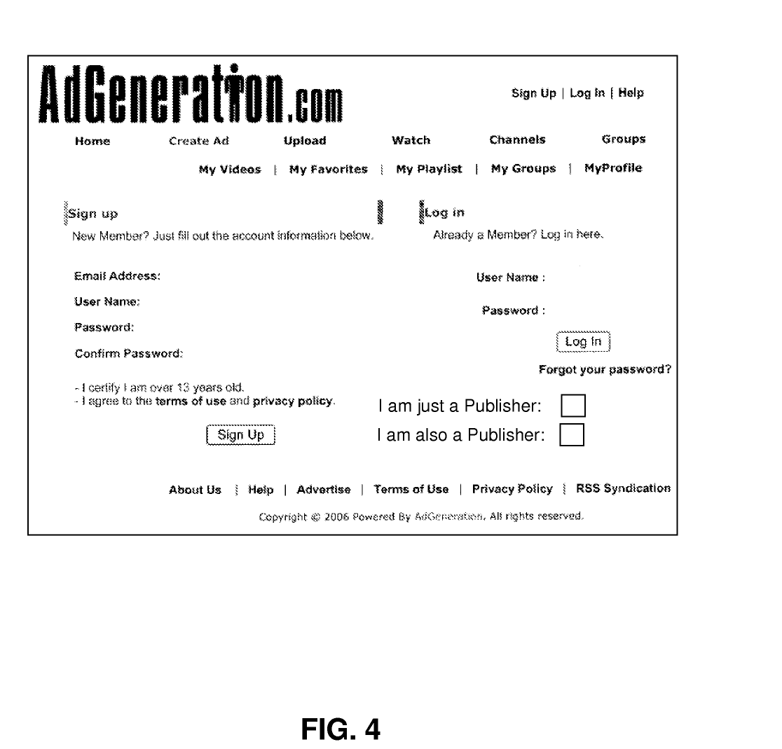

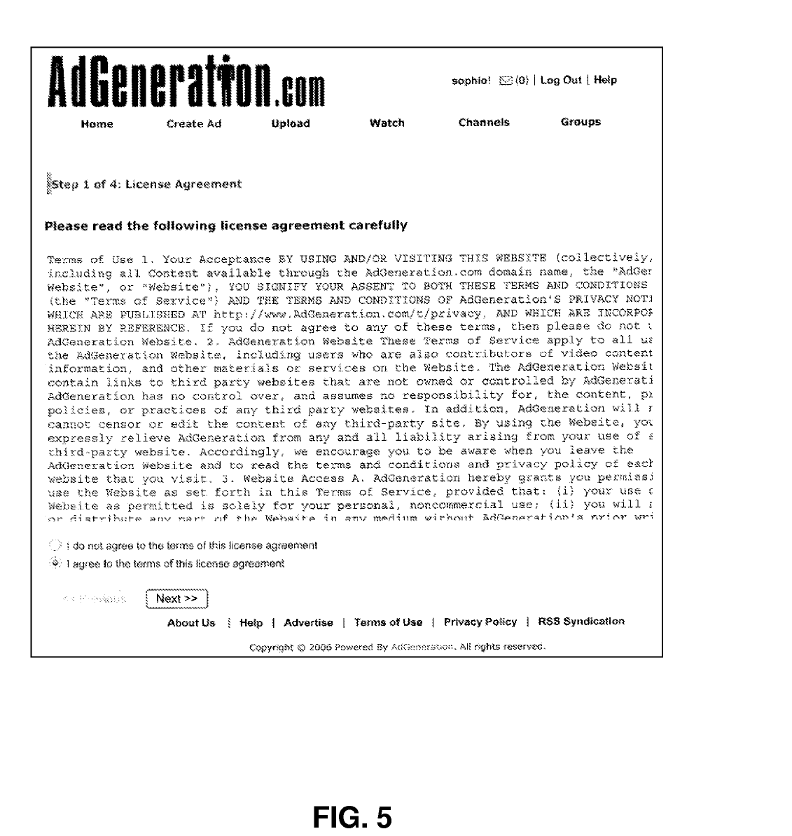

Use of the given website or the ads uploaded or generated through the given website can be tracked or monitored. Obviously, users that log in as noted in the screenshots of FIGS. 3-5 can be tracked to a reasonable extent to enable the appropriate distribution of revenue share payments for ads uploaded or created on the given site. Furthermore, consumer-creators can have generated code (for example, in the form of HTML snippets) as shown in FIG. 9 that they can place (or the system can automatically place) on third party websites to further facilitate revenue share and tracking of such ads. As can be seen, the website in FIG. 3, can be a site that enables users to share and view content, but the embodiments are not limited to such a website. In FIG. 4, different types of users can register and log in. As is common with many websites, the user might also encounter a click-wrap license as illustrated in FIG. 5 that can define the relationships between the website and the different types of users.

All views of the user generated content (UGC) or ads can be metered and have the ability to be voted on by visitors. Whereas standard pay per click ‘text’ advertisement has a single link that enables a user to link directly to the advertised website, embodiments herein can also include an additional link or image to click on that can affect the consumer-creator's score. For example, the consumer-creator can start at 100% and decrease if their ‘word of mouth’ recommendation is voted in a negative fashion by a visitor in the network. For example, a restaurant recommendation that turns out as a bad recommendation can give the visitor or ad consumer the ability to criticize the consumer-creator and consequently enable the return to the consumer-creator's profile page resulting in a decrease in score from 100% to 99% and so on from a negative score. This score can be a link that brings the visitor to the profile page of the consumer-creator frequently or repeatedly. This data will be available to consumer-creators so that they have a benchmark for which companies and or genres may be most valuable to create ads for. Visitors can create an account similar to accounts found at other social networking websites whereby their account can be accessed with a friendly name such as www.AdGeneration.com/michael. The visitors profile can have personally identifiable information on it helping other visitors to connect with them if the visitor is interested in networking with others. Other shortcuts to their favorite advertisements and or publishers can be added. The visitors in some instances can possibly participate in some of the ad sharing revenue as well. For example, if a celebrity created a visitor account and shared their ideas and interests with the world, their page would receive lots of traffic. This in turn can lead to revenue generated for all parties, the visitor, the publisher, and ultimately the advertiser who is receiving the traffic from the ‘word of mouth’ referrals.

An Advertiser can be a company (or other entity or individual) willing to pay for clicks received as the result of a bona fide click through from any number of ads, located at any number of sites. The advertiser might be a new car dealer, a fortune 500 company, a plumber or a local handyman or barber, or a start-up dot.com selling video games online. All advertisers can pay the owner of the given website for unique click-throughs to their website (whether the click-throughs occurred from the given website or from other third party website).

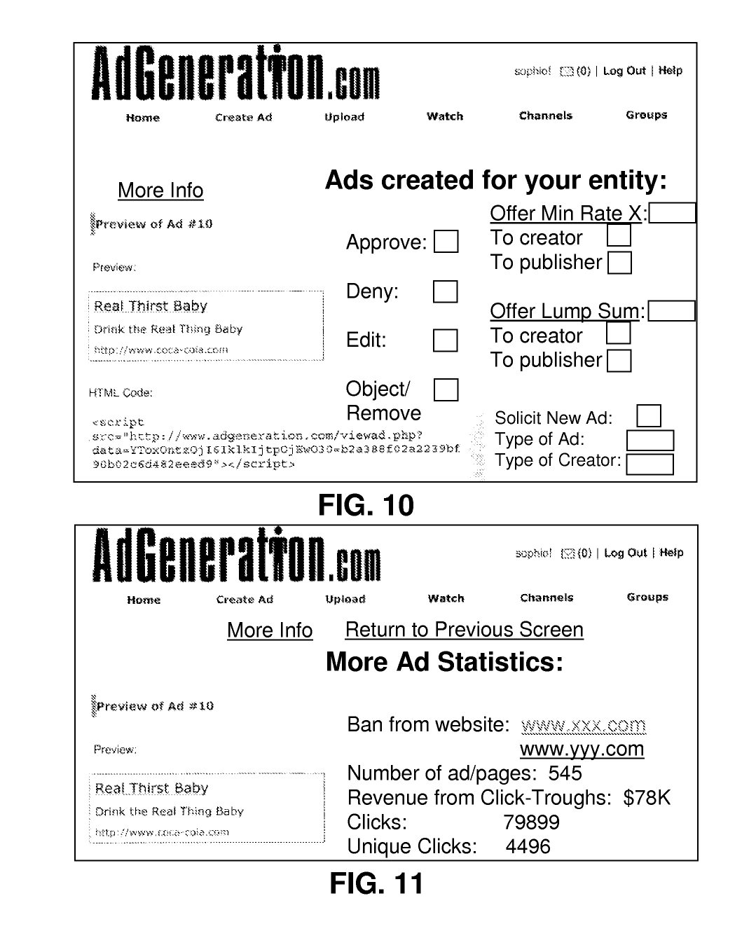

Advertisers can come to the home page for the given website and click a link or button labeled ‘Advertisers’ as shown in FIG. 3. A page will be displayed allowing them to sign up for an account or login to an existing account similar to the screen in FIG. 4. Once they login they will be asked for their contact information (email, phone, fax, name, company name, address, zip/postal, country, billing information (cc number, expiration date, security code), SIC and business information, and desired username and password at the site. There can be additional pages for the advertiser login that can allow them to see all of the ads created for their company, and the ability to approve or deny them or in some instances to edit such ads as illustrated in FIG. 10. If an ad is approved an email can be sent to the consumer-creator informing them that their ad was approved by the Advertiser. A notice can also be sent to the consumer-creator in the event of a denial or edit of such an ad.

The advertiser can also determine the value of the traffic that they receive from the given website as well as the commission rate they wish to share with creators and publishers as shown in FIG. 10. There can be minimum rate set by advertiser or a lump sum buyout offered to creators (or publishers if appropriate, e.g., when publishers have the entire rights acquired from creators). For example, an Advertiser may want a new TV spot created. They may offer the creator a fixed buyout of $25,000, or simply decide to pay $0.50 per click if the campaign is internet only.

If the advertiser allows the network to generate ads as they see fit, the advertiser can also be able to access the various pages that their advertisements are being displayed on. The Advertiser can click a link first that shows the user generated content or ad, then a second link can be provided that allows the advertiser to see where the ad is being displayed and or distributed. If the Advertiser is a large company there could be tens of thousands of ads. If this is the case, the ads can be grouped into categories and or genre's to make it easier to sift through. If there is an objectionable location, the Advertiser may ban the ad as they see fit. If this occurs, an email can be sent to the creator and publisher simultaneously informing them of the ban. If a creator receives too many bans, they may be expelled permanently from the network. A similar system is used at eBay for ranking buyers and sellers. Each ad can have statistics associated with it as illustrated in FIG. 11, which can be viewed by the advertiser so that the effectiveness can be measured. The same pages can have counts provided (number of ads, number of pages ad is displayed on, number of ‘gross’ clicks received from ad, number of ‘unique’ clicks received from ad, $ of revenue generated from Conversions received from click-throughs.

Advertisers can also solicit for new ads and specify the type. This can be similar to the many generalized freelance websites on the Internet today such as guru.com and scriptlance.com. Advertisers seeking ‘art and imagery’ for business cards all the way through high end television commercials can be posted as a request for content with a fixed or bid price. They can also choose the type of creator they are interested in receiving content and bids from. (See lower, right side of FIG. 10).

A creator (or consumer-creator) can be a person or company who creates original content with the hopes of selling their user generated advertisement or content or endorsement to an Advertiser. A creator's content can often be created in advance of an advertiser requesting the content to be created. The premise is that a large number of ads created for a given advertiser can help convince the future advertiser that the user generated advertisements are a lucrative and creative way of building their own brands. Since visitors to the given website may also be future Advertisers, the visitors can also essentially preview the ads they may decide to pay to start using.

A creator can be anyone. A creator can be a thirteen year old boy or girl, a superstar advertising executive from the nation's largest Advertising firm, an up and coming cinematographer, a garage rock-n-roll band, a rap video producer, or a world famous celebrity. Creators can receive a share of the advertising revenue generated from their advertisements. This revenue share can be determined by the Advertiser, and will have a flexible fee.

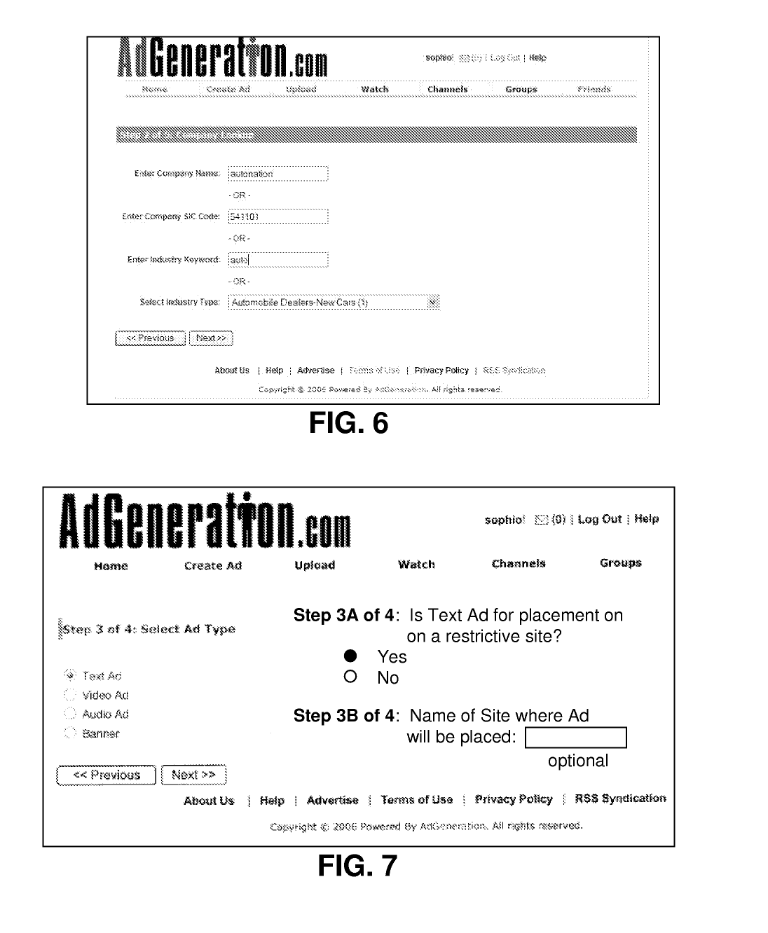

Creators can simply go to the given website home page or other page and click a link or button labeled ‘Create Ad’ as shown in FIGS. 6 and 7. A page will be displayed allowing them to sign up for an account or login to an existing account. Once they login they can be asked for their contact information (email, phone, fax, name, company name, address, zip/postal, country, billing information (cc number, expiration date, security code), SIC and business information if applicable, and desired username and password to be used at the given website. They can at this time check a box to alert the given website that they are also a Publisher (See FIG. 4). The creator may have a popular social networking page that receives thousands of page views daily. The creator can then monetize these page views by click throughs from the visitors to this or some other consumer-creator's ads at these pages.

If the creator is just browsing to get ideas of who to create ads for, there can be a catalog of companies organized by category and genre that they may wish to select from. If the creator wants to add a company to the list they can also do so provided the URL and company information they give are valid. The given website staff can confirm prior to publishing that the company and URLs entered are in fact valid. Once a creator selects a company or adds one, the URL of the company selected can automatically be assigned to the uploaded or created ad. This URL listing can be set up such that it can only be changed by the owner of the particular URL once the ad is published. This is to maintain consistency in the ad network.

There can be additional pages for the creator or consumer-creator to login that will allow them to see all of the ads that they have created with various statistics that will include similar statistics viewed by the advertiser or more: number of sites the ad was placed on, number of clicks the ad has received, total dollars of revenue generated, gross clicks, unique clicks, and other geographic and analytical data snippets that would be valuable to the creator for building additional successful ads. From this same page the creator can delete ads, or change them. Once an ad is changed, it will automatically be disabled at publisher sites if publishers have checked an option box that requires all ads to be approved. If an ad is approved by an Advertiser an email will be sent to the creator informing them that their ad was approved by the Advertiser and the commission rate and terms of payment will be provided. This same information can be available from within the creator's account page.

Another page can be available to the creator that allows them to upload from their PC the advertisement created. If the ad is text only, the creator can type the ad directly on the page. There will be several different ad types that range from static images, dynamic images, audio, text, video and other forms of multi media. Further note in FIG. 7 that the given website enables the creator to inform the system whether the text ad will be placed on a restrictive site that may not allow certain embedded scripts. As will become more apparent, such restrictive sites (such as MySpace and YouTube) still allow video with similar embedded scripts or code and the given website can translate a text ad script into a video ad as needed. The creator can optionally inform the given website as to where the ad is intended to be placed (e.g., target or host website or publisher) to enable an appropriate translation into a format acceptable by the target or host website or publisher. Each ad created may also require the creator to assign a title, description, and list of keywords associated with the ad. This information can be optionally reviewed by the website staff to maintain consistency in the network. The various data assigned to the ad can be stored in a database to make it possible to create an Ad engine database that can be searched and or syndicated at Affiliate sites. For example, if an individual wants to see a search of all audio ads created for Coca Cola, I can enter ‘coca cola’ and select a checkbox for ‘audio’.

The ad types will change over time as the Internet Browsers themselves allow additional forms of content to readily be viewed or heard. Advertisers or host websites may allow a creator's video ad but not an audio one or they might allow video (e.g., as Flash or other formats) but not text. The given website contemplates having to do some modification, translation or conversions based on known restrictions at host websites. Furthermore, the given website can be used to create offline ads and the same model can be used for the storing, retrieving and compensating of same.

Creators can be paid on a periodic basis. Publishers can also hand pick the ads they want to use at their site or they can use a contextually sensitive ad feed similar to Google's Adsense which figures based on the content of the web page what ads should be placed. Creators may also wish to bid or create content for ads found in the Ad marketplace. This process will be fairly generic in the same vein as an online classifieds section.

A publisher is a person or company who has their own domain name with the ability of placing advertisements on it. Some publishers will be large like Amazon.com, MSN.com and Google, while others might be consumers or visitors that have profile pages at social networking sites such as MySpace.com, FaceBook, Friendster, youtube, etc. It can be the publisher's responsibility to take HTML code or other appropriate types of code generated at the given website and place it in acceptable locations throughout their online publications. The HTML code generated at the given website can be standard code that works in all well known web browsers such as Internet Explorer, FireFox, Safari and other popular web browsers. As noted above, several sites such as Myspace, YouTube and the like do not allow the embedding of ‘scripts’ or the HTML snippets (of FIG. 9) in a profile page, but they allow the embedding of ‘video’. Thus, the given webpage provides a user friendly front end to allow creators to create text ads while the given webpage's backend creates or translates the text script into a small ‘video’ to display “pseudo-text” on the restrictive site. The given website can even allow creators to select among introductory templates that are appended to their text based ad to enable smoother or more seamless transitions at the host websites or publishers. For example, such template can be a video that says or displays ‘The link you are about to see was created by me, because I absolutely love this product (or service).’ Then the video fades to black with white (or other transition where the) text then shows the simple standard Title, Subject, and URL to be clicked.

In one embodiment, Publishers who are not creators can receive a percentage of the click through revenue generated at their publication. This rate will be a minimum established rate for all advertisers to pay and may be different for each advertiser for each ad. Publishers can come to the given website home page or other page and click a link or button labeled ‘Publishers’. A page can be displayed allowing them to sign up for an account or login to an existing account. Once they login they will be asked for their contact information (email, phone, fax, name, company name, address, zip/postal, country, billing information (cc number, expiration date, security code), SIC and business information if applicable, and desired username and password to be used.

Similar to the advertiser and creator pages, there can be additional pages for the Publisher login that will allow them to see all of the ads that they have selected to be displayed at their publication, along with various statistics that will include: number of ads shown, pages the ad was placed on, number of clicks the ad has received, total dollars of revenue generated, gross clicks, unique clicks, and other geographic and analytical data snippets that would be valuable to the Publisher to determine which ads could possibly be removed from their publication. From this same page the Publisher can delete ads that they find offensive or inappropriate for their site. Once removed, it can automatically be disabled on all of the Publishers pages. If an ad is changed by a creator the Publisher can opt-in to receive email notifications of this event. Publishers can be paid on a periodic basis and any type of payment method including electronic fund transfer (EFT) is certainly contemplated.

An affiliate can be someone who promotes the use of the given website throughout the Internet. The intent of an affiliate is to send the various types of users to the given website and be paid a one time fee for doing so. The affiliates account is quite limited when compared to a creator or Advertiser. Affiliates can come to the home page and click a link or button labeled ‘Affiliates’ as shown in FIG. 3. A page can be displayed allowing them to sign up for an account or login to an existing account similar to the way a visitor or creator or advertiser or publisher would sign up. Once they login, they can be asked for their contact information (email, phone, fax, name, company name, address, zip/postal, country, payment information (bank account number, routing number, bank info), SIC and business information if applicable, and desired username and password to be used. There can be additional pages for the Affiliate login that will allow them to see all of the users that signed up as a result of their referral and the money it has generated the Affiliate. In one particular embodiment, the Affiliates will not be able to see the personal or business contact information other than the geographic and SIC grouped information for purposes of helping them enhance their referral activities.

A system in accordance with the invention can also offer ‘template’ advertisements that could be selected by the user for the more inexperienced or first time user. For example, if building a simple ‘text’ link, the user might be able to choose from a list of existing ‘titles’, and then from a list of existing ‘body content’. If it is a video ad the new creators are trying to create, they might simply use the video and insert their ad in front or behind the commercial or superimpose the text at an appropriate time frame.

The system can be designed to avoid having people seeking for the ‘highest paying’ advertisers to create ads for them and instead encourage ads that are based on personal experience to promote the whole concept of ‘word of mouth’ Internet advertising. One method to validate and encourage such usage can involve automatic validation of ad content. For example, if a consumer-creator creates more than one ad for the same classification (SIC/NAICS) code, the system can warn the user that they cannot create such an ad for such entity since they have already selected ‘ONE AUTO REPAIR SHOP’ (i.e., they already created an ad for an entity in a given classification and can now only choose ad creations for entities in other classifications or ads only for the existing entity in the given classification.)

A basic tenet of building a website or a community or advertising in general in accordance with the embodiments is the concept of trust. Advertising has only become more and more intrusive on the Internet engendering more and more distrust. Ads now float across the screen as a reader tries to read an article. Ads sometimes take up half the screen until the user is forced to close them or make obnoxious noises to the reader's attention. These kinds of ads will likely backfire on the advertisers due to their intrusiveness. A model of a successful Internet business that incorporates trust is EBAY. EBAY allows positive or negative feedback every time a sale is made. This allows buyers and sellers to consider the reputation of the person or company they are doing business with before entering into a legal transaction. Many EBAY sellers have several thousand transactions with 100% positive reviews. This increases the chance that if there are 10 of the same product for sale at the same price that the seller with the most positive feedback will get the sale. The system encourages sellers of products to go out of their way to be professional and respond to any complaint in order to keep their feedback 100% positive. There is nothing more powerful than hundreds of good feedback comments, or a large amount of negative feedback. It makes or breaks sales. EOPINIONS is a website that allows consumers to post opinions on a variety of products, but there is no incentive for positive opinions about products. So the website ultimately becomes riddled with negative opinions from people who generally have incentive to provide poor opinions since it has become an outlet for frustrated consumers.

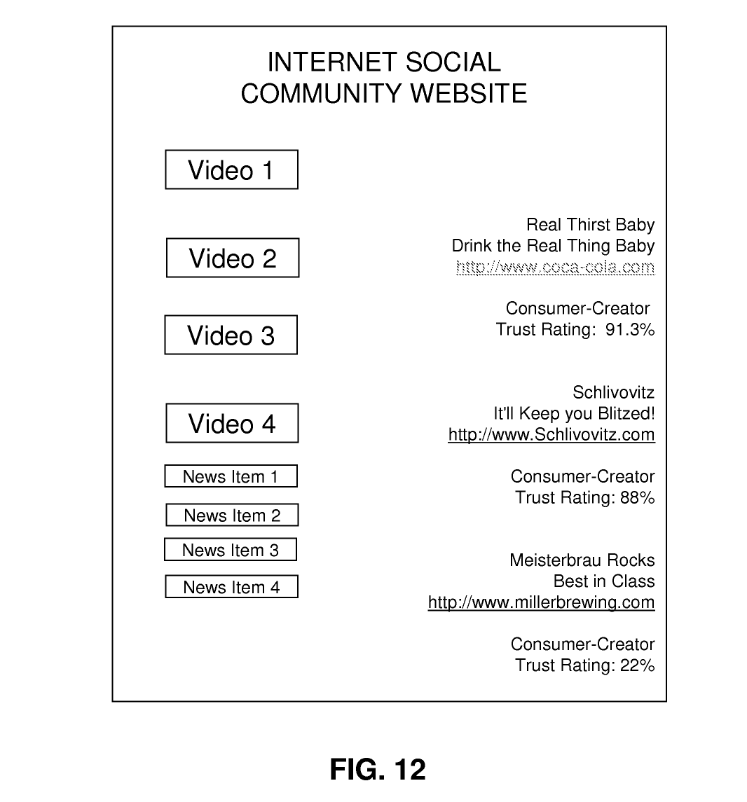

No existing website has made the consumer the most important part of a sale. As noted above, a website in accordance with the embodiments can have the consumer sign up for an account and post ads in any format they wish for products and services they highly favor. These ads are then available for company or advertiser approval and the offering of a monetary incentive to the consumer-creator. The monetary incentive encourages someone who will typically just tell a few friends about a product to tell millions of people about it by posting it on their own personal web page or blog. Once the advertising company approves the ad, it is available much like Google AdSense to be published on web pages as illustrated in FIG. 12. However unlike Google AdSense, the ads are written by consumers instead of companies and the consumer gets rewarded in addition to the publisher who may be hosting the advertisement. Furthermore, like the EBAY model, each consumer-creator of ads can have a score indicating how trusted he or she is. Similarly to EBAY, the consumer will look for the most trusted consumer ads before making a purchase or possibly even making a decision to click to a particular website. The score of the consumer-creator or publisher can be a formula based on feedback on purchases of products resulting from the consumer-creator's ad.

For example, if one wants to buy an LCD TV and types it into a search query, the person searching (e.g., visitor) will see ads about LCD TV's written by advertisers on each website the visitor visits. The typical response by an intelligent consumer is to click a few different sites comparing prices and information before making a purchase. This increases the cost to the advertiser because each click costs money. By using a system having ads generated in accordance with the present invention, the visitor or consumer can see (or otherwise have easy access to) a trust rating associated with the ad. Instead of flailing around many Internet sites looking for a good deal and information, the consumer just can look for a consumer-generated ad that has a high trust rating. This arrangement reduces the time to find products, the stress over whether they are good products, and reduces the amount of clicks a user makes to find such a product. Like EBAY's feedback score, the consumers (i.e., consumer-creators) who are generating the ads will go out of their way to only advertise websites, brand, and companies they know are good. Building a solid positive reputation will earn them money. There is a built-in disincentive for consumer-creators to lie or create ads for products that are not highly rated.

Such a system can benefit consumers and put companies selling shoddy or misleading products in further jeopardy due to the greater free-flow of consumer information. Such a system can result in a consumer finding a great product fast, a consumer creator of an ad getting paid by just writing a simple testimonial ad, and a publisher of the ad drawing additional eyes to the ads on their site which gets them more clicks. The advertising company pays less overall for their marketing because the ads are now trusted by the consumer, thus resulting in fewer clicks, views, or impressions to generate a sale (higher conversion rates).

Note, there are any number of ways or algorithms for providing or creating a sense of trust in the context of consumer generated advertising. One scheme can start individuals with a 100% rating or ranking on an ad by ad basis. Alternatively, ratings can be based on rankings for a conglomeration of different ads created by an individual consumer-creator. Other aspects can also provide for automatically removing (or lowering priority for) particular ads or even particular consumer-creators from the system once their trust rankings fall below a predetermined threshold. Such a scheme can reduce clutter and give priority in placement of ads to trustworthy consumer-creators (as shown in FIG. 12) and even enable consumer-creators to raise their trust rankings by removing ads with poor rankings.

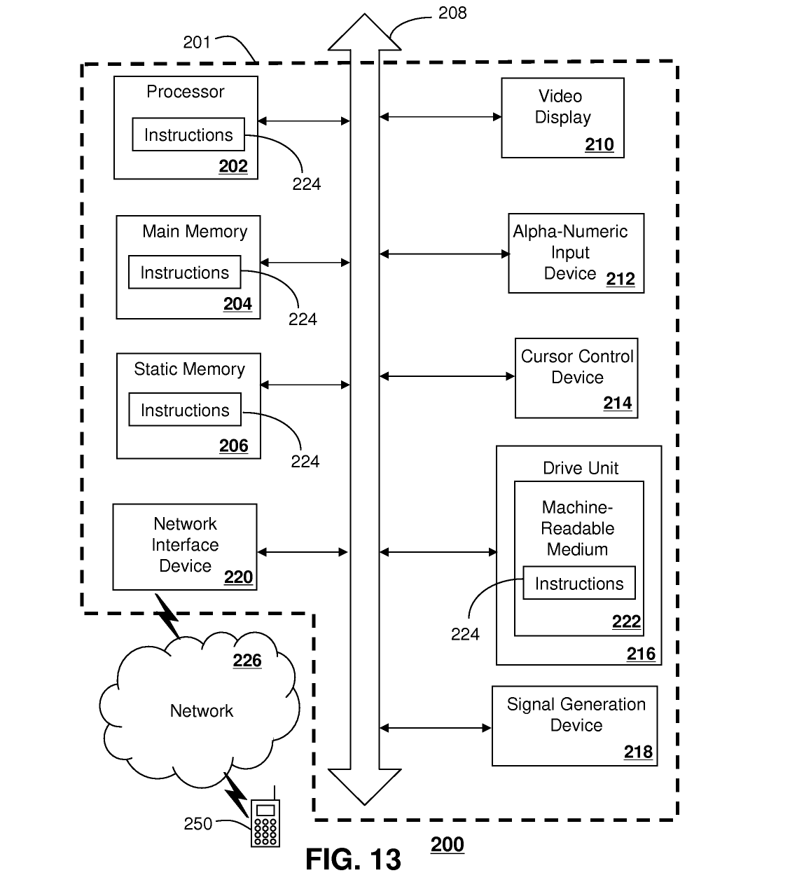

FIG. 13 depicts an exemplary diagrammatic representation of a machine in the form of a computer system 200 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. For example, the computer system can include a recipient device 201 and a sending device 250 or vice-versa.

The machine may comprise a server computer, a client user computer, a personal computer (PC), a tablet PC, personal digital assistant, a cellular phone, a laptop computer, a desktop computer, a control system, a network router, switch or bridge, or any machine capable of executing a set of instructions (sequential or otherwise) that specify actions to be taken by that machine, not to mention a mobile server. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 200 can include a controller or processor 202 (e.g., a central processing unit (CPU), a graphics processing unit (GPU, or both), a main memory 204 and a static memory 206, which communicate with each other via a bus 208. The computer system 200 may further include a presentation device such as a video display unit 210 (e.g., a liquid crystal display (LCD), a flat panel, a solid state display, or a cathode ray tube (CRT)). The computer system 200 may include an input device 212 (e.g., a keyboard), a cursor control device 214 (e.g., a mouse), a disk drive unit 216, a signal generation device 218 (e.g., a speaker or remote control that can also serve as a presentation device) and a network interface device 220. Of course, in the embodiments disclosed, many of these items are optional.

The disk drive unit 216 may include a machine-readable medium 222 on which is stored one or more sets of instructions (e.g., software 224) embodying any one or more of the methodologies or functions described herein, including those methods illustrated above. The instructions 224 may also reside, completely or at least partially, within the main memory 204, the static memory 206, and/or within the processor 202 during execution thereof by the computer system 200. The main memory 204 and the processor 202 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but are not limited to, distributed processing or component/object distributed processing, parallel processing, or virtual machine processing can also be constructed to implement the methods described herein. Further note, implementations can also include neural network implementations, and ad hoc or mesh network implementations between communication devices.

The present disclosure contemplates a machine readable medium containing instructions 224, or that which receives and executes instructions 224 from a propagated signal so that a device connected to a network environment 226 can send or receive voice, video or data, and to communicate over the network 226 using the instructions 224. The instructions 224 may further be transmitted or received over a network 226 via the network interface device 220.

While the machine-readable medium 222 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a midlet, a source code, an object code, a shared library/dynamic load library and/or other sequence of instructions designed for execution on a computer system.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method whereby consumer-creators can create advertisements on behalf of advertisers on an electronic network, comprising the steps of:
uploading or creating an ad on a given website by a consumer-creator;
offering the ad to advertisers or publishers or visitors for presentation on various electronic medium selected among text, audio, video, image, flash, swift, podcasted data, zunecasted data, or animated gif, wherein the ad is available on the given website or linked to the given website from another website;
enabling the selection of an ad that has been uploaded or created by the consumer-creator by an advertiser or a publisher or visitor;
brokering a relationship among the consumer-creator, the visitor, the advertiser, or the publisher;
tracking usage of the ad; and
automatically enabling payment for the use of the ad based on the relationship brokered and the use tracked of the ad.

2. The method of claim 1, wherein the ad is placed on a website that automatically links an ad on a third party's website that redirects a visitor to third party's website to an advertisers' website.

3. The method of claim 1, wherein the method further comprises the step of enabling visitors to view ads uploaded or created on the given website and further enabling the visitors to directly click the ad and visit the advertisers website.

4. The method of claim 3, wherein the method further optionally charges the advertiser a fee for clicking the ad at the given website.

5. The method of claim 4, wherein the method further charges the advertiser a higher fee if the visitor affirmatively opts to be linked to a website associated with the ad and charges the advertiser a lower fee if the visitor affirmatively opts to just view the advertisement.

6. The method of claim 1, wherein the given website enables a visitor or a consumer-creator to join a social network on the given website or on a third party website and to have personalized web storage space where the ad can be placed and enabling the visitor to share in advertising revenue based on monitored traffic resulting from the ad.

7. The method of claim 1, wherein the method further enables the given website to automatically charge the advertiser a fee based on unique click-throughs to an advertiser website resulting from the ad generated by the consumer-creator.

8. The method of claim 1, wherein the method further enables the advertiser to view ads created for the advertiser, approve the ads, deny the ads, modify the ads, wherein an email or traditional mail is automatically generated and sent to the consumer-creator if the ad was approved by the advertiser.

9. The method of claim 8, wherein the method further enables the offering of a commission or a lump sum buyout by the advertiser to the consumer-creator.

10. The method of claim 9, wherein the method further sets minimum rates for the commission or the lump sum based on existing statistics for the ad or other standards and the intended use by the advertiser.

11. The method of claim 1, wherein the method enables an advertiser to access websites and statistics about where ads generated by the consumer-creator are being displayed or distributed and further enables the advertiser to optionally ban a website or a category of website from using their ad, wherein such a ban automatically generates an email or other correspondence to the consumer-creator or publisher informing them of the ban.

12. The method of claim 1, wherein the method further enables the advertiser or visitor to view ranking of ads and further enables the advertiser to see statistics for the ads among number of ads, number of pages the ad is displayed on, number of gross clicks received from the ad, number of unique clicks received from the ad, or an estimated amount of revenue generated from click-throughs.

13. The method of claim 1, wherein the method can further enable solicitations from the advertiser for a particular type of ad with an offer at a fixed price or a bid price and an option request for ads from a particular type of consumer-creator.

14. The method of claim 1, wherein the method can further enable a consumer-creator to inform the given website that the consumer-creator is also a publisher, affiliate or advertiser.

15. The method of claim 1, wherein the method further enables the consumer-creator to select an advertiser by which the consumer-creator will associate the ad and the given website automatically assigns a URL and tracking identification number for the selected advertiser to be associated with the ad, wherein only the advertiser can change the URL once the ad is published.

16. The method of claim 1, wherein the method further enables consumer-creators to login and allow consumer-creators to see ads that they have created with associated statistics among number of sites the ad was placed on, number of clicks the ad has received, total dollars of revenue generated from the ad, gross clicks, unique clicks, geographic and other demographic data.

17. The method of claim 1, wherein the method further enables consumer-creators to login and upload, create, delete or edit ads, wherein edits to the ad automatically disables ads at a publisher's site if the publisher or advertiser elected to have all ads approved, wherein a subsequent approval of an edited ad will automatically generate an email or other correspondence to the consumer-creator.

18. The method of claim 1, wherein publishers use a contextually sensitive ad feed that uses the content of a publishers website to determine which ad from the given website to be placed on a publisher's website.

19. The method of claim 1, wherein the method enables a publisher to use HTML code generated at the given website and place the HTML code in their online publications, wherein the HTML is compatible with all publicly available web browsers including Internet Explorer, FireFox, Safari and other iterations of same.

20. The method of claim 1, wherein the publishers who are not consumer-creators receive a percentage of click-through revenue generated at their publication, wherein a minimum rate is established for advertisers to pay for each ad.

21. The method of claim 1, wherein the publishers are enabled to see ads that the publishers have selected to be displayed at their publication, along with various statistics that include among number of ads shown, pages the ad was placed on, number of clicks the ad has received, total revenue generated, gross clicks, unique clicks, and other geographic and analytical data snippets that are valuable to the publisher to determine which ads to remove or keep on the publisher's publication.

22. The method of claim 1, wherein the method enables a publisher to delete ads that the publisher finds offensive or inappropriate for their site and further automatically disables the ad on all of the Publishers pages and additionally informs the consumer-creator via email that a given ad was removed due to its content.

23. The method of claim 1, wherein the method further enables a publisher to opt-in to receive an email notification if an ad is changed by the consumer-creator.

24. The method of claim 1, wherein the method further enables the registration by an affiliate and further enables the affiliate to see all of the users that signed up as a result of their referral and the revenue the affiliate has generated as well as some statistical data among geographic and SIC grouped information for purposes of helping the affiliate enhance their referral activities.

25. The method of claim 1, wherein the method further comprises the step of tracking how many consumer-creators created an ad for an advertiser's website, tracking how many consumer-creators or visitors clicked on the ad, or tracking how consumer-creators or visitors viewed the ad.

26. The method of claim 1, wherein the method further comprises the step of enabling a consumer-creator to use a ‘wizard’ style interface to build an ad.

27. The method of claim 26, wherein the method further comprises the steps of enabling a consumer creator to enter a keyword to search an electronic database that returns a list of SIC and or NAICS descriptions to identify a government industry specification, enabling the selection of companies assigned to the government industry specification, storing a company identifier and URL associated with a selected company, and pre-populating an online form to associate the ad with the information associated with the selected company.

28. The method of claim 27, wherein the method further comprises the steps enabling the selection of an ad type, displaying a title, content, and keyword boxes for the ad, and generating HTML code for transfer to other web pages by storing the HTML code in the consumer-creator's local memory.

29. An advertising portal, comprising:
means for uploading or generating an ad to the advertising portal by a consumer-creator;
means for offering the ad to advertisers, publishers, or visitors to the advertising portal;
means for selecting the ad;
means for brokering a relationship between a consumer-creator, the advertisers, the publishers, or the visitors;
means for tracking the ad selected using link driven statistical analysis;
means for automatic payment to the consumer-creator, publishers or visitors based on the relationship brokered and the statistical analysis; and
means for an advertiser to request an ad to be created by a consumer-creator.

30. A machine-readable storage, having stored thereon a computer program having a plurality of code sections executable by a machine for causing the machine to perform the steps of:
uploading or creating an ad on a given website by a consumer-creator;
offering the ad to advertisers or publishers or visitors for presentation on various electronic medium, wherein the ad is available on the given website or linked to the given website from another website;
selecting an ad by an advertiser or a publisher or visitor that has been uploaded or created;
brokering a relationship among the consumer-creator, the visitor, the advertiser, or the publisher;
tracking use of the ad; and
automatically enabling payment for the use of the ad based on the relationship brokered and the use tracked of the ad.

31. The machine-readable storage of claim 30, wherein the machine-readable storage is further programmed to enable visitors to view ads uploaded or created on the given website and further enable the visitors to select a link associated with an ad and further optionally charge the advertiser a fee for selecting the link associated with the ad at the given website.

32. The machine-readable storage of claim 30, wherein the machine-readable storage is further programmed to enable a visitor to join a social network on the given website or on a third party website and to have a personalized webspace where the ad can be placed and enable the visitor to share in advertising revenue based on monitored traffic resulting from the ad.

33. The machine-readable storage of claim 30, wherein the machine-readable storage is further programmed to enable the given website to automatically charge an invited advertiser a fee based on unique click-throughs to an advertiser website resulting from the ad.

34. The machine-readable storage of claim 30, wherein the machine-readable storage is further programmed to enable the advertiser to view ads created for the advertiser, approve the ads, deny the ads, wherein an email or other correspondence is automatically generated and sent to the consumer-creator if the ad was approved by the advertiser.

35. The machine-readable storage of claim 34, wherein the machine-readable storage is further programmed to enable the offering of a commission or a lump sum buyout by the advertiser to the consumer-creator and further sets minimum rates for a commission or a lump sum based on existing statistics for the ad and the intended use by the advertiser.

36. The machine-readable storage of claim 30, wherein the machine-readable storage is further programmed to enable an advertiser to access websites or statistics about where their ads are being displayed or distributed and further enables the advertiser to optionally ban a website or a category of website from using their ad, wherein such a ban automatically generates an email to the consumer-creator or publisher informing them of the ban.

37. The machine-readable storage of claim 30, wherein the machine-readable storage is further programmed to enable the advertiser or visitor to view ranking of ads and further enable the advertiser to see statistics for the ads among number of ads, number of pages the ad is displayed on, number of gross clicks received from the ad, number of unique clicks received from the ad, or an estimated amount of revenue generated from click-throughs.

38. The machine-readable storage of claim 30, wherein the machine-readable storage is further programmed to enable solicitations from the advertiser for a particular type of ad with an offer at a fixed price or a bid price and an option request for ads from a particular type of consumer-creator.

39. The machine-readable storage of claim 30, wherein the machine-readable storage is further programmed to enable a consumer-creator to inform the given website that the consumer-creator is also a publisher.

40. The machine-readable storage of claim 30, wherein the machine-readable storage is further programmed to enable the consumer-creator to select an advertiser associated with the ad and the given website automatically assigned a URL for the selected advertiser to be associated with the ad, wherein only the advertiser can change the URL once the ad is published.

41. The machine-readable storage of claim 30, wherein the machine-readable storage is further programmed to enable consumer-creators to login and allow consumer-creators to see ads that they have created with associated statistics among number of sites the ad was placed on, number of clicks the ad has received, total dollars of revenue generated from the ad, gross clicks, unique clicks, and geographic data.

42. The machine-readable storage of claim 30, wherein the machine-readable storage is further programmed to enable consumer-creators to login and upload, create, delete or edit ads, wherein edits to the ad automatically disables ads at a publisher's site if the publisher or advertiser elected to have all ads approved, wherein a subsequent approval of an edited ad will automatically generate an email to the consumer-creator.

43. The machine-readable storage of claim 30, wherein the machine-readable storage is further programmed to enable a publisher to use HTML code generated at the given website and place the HTML code in their online publications, wherein the HTML is compatible with web browsers including Internet Explorer, FireFox, and Safari.

44. The machine-readable storage of claim 30, wherein the machine-readable storage is further programmed to enable publishers to see ads that the publishers have selected to be displayed at their publication, along with various statistics that include among number of ads shown, pages the ad was placed on, number of clicks the ad has received, total revenue generated, gross clicks, unique clicks, and other geographic and analytical data snippets that valuable to the publisher to determine which ads to remove or keep on the publisher's publication.

45. The machine-readable storage of claim 30, wherein the machine-readable storage is further programmed to enable a publisher to delete ads that the publisher finds offensive or inappropriate for their site and further automatically disables the ad on all of the Publishers pages.

46. The machine-readable storage of claim 30, wherein the machine-readable storage is further programmed to enable a publisher to opt-in to receive an email notification if an ad is changed by the consumer-creator.

47. The machine-readable storage of claim 30, wherein the machine-readable storage is further programmed to enable the registration by an affiliate and further enables the affiliate to see all of the users that signed up as a result of their referral and the revenue the affiliate has generated as well as some statistical data among geographic and SIC grouped information for purposes of helping the affiliate enhance their referral activities.

48. The machine-readable storage of claim 30, wherein the machine-readable storage is further programmed to convert an ad from one format to another.

49. The machine-readable storage of claim 30, wherein the machine-readable storage is further programmed to enable the consumer-creator to embed or attach a logo or emblem of an advertiser or of the consumer-creator into a video or other multimedia presentation created by the consumer-creator.

50. The machine-readable storage of claim 30, wherein the machine-readable storage is further programmed to modify or translate a created or uploaded ad and any corresponding code or script into a format for use on a publisher or host website having known restrictions.

51. A method of ranking consumer-creator generated ads for use on a website on a computer network, comprising the steps of:
enabling the uploading or creating of an ad on a given website by a consumer-creator;
placement of the ad on a third party website, wherein the ad enables click-throughs to an advertiser website;
tracking how many consumer-creators created an ad for the advertiser website; and;
ranking the ad based on the tracking.

52. The method of claim 51, wherein the method further comprises the step of displaying the ad in an order based on the ranking.

53. The method of claim 51, wherein the method further comprises the step of tracking how many visitors or consumer-creators clicked on the ad or tracking how many consumer-creators or visitors viewed the ad.

54. The method of claim 51, wherein the method further comprises the step of tracking how many unique visitors or unique consumer-creators clicked on the ad or tracking how many unique consumer-creators or unique visitors viewed the ad.

55. The method of claim 51, wherein the method further comprises the step of ranking the ad based on a number of positive or negative feedback comments that the consumer-creator received for the ad.

56. The method of claim 51, wherein the method further comprises the steps of:
offering the ad to advertisers or publishers or visitors for presentation on various electronic medium, wherein the ad is available on the given website or linked to the given website from another website;
selecting an ad by an advertiser or a publisher or visitor that has been uploaded or created;
brokering a relationship among the consumer-creator, the visitor, the advertiser, or the publisher;
tracking a use of the ad; and
automatically enabling payment for the use of the ad based on the relationship brokered and the use tracked of the ad.
